(19) United States
(12) Patent Application Publication
(10) Pub. No.: US 2014/0032019 A1
(43) Pub. Date: Jan. 30, 2014

(54) Device and Method for Managing the Strategy to Join Waypoints

(71) Applicant: THALES, Neuilly/sur/seine (FR)

(72) Inventors: Romain COURTEVILLE, TOULOUSE (FR); Bertrand BARNETCHE, TOULOUSE (FR)

(21) Appl. No.: 13/946,828

(22) Filed: Jul. 19, 2013

(30) Foreign Application Priority Data
Jul. 27, 2012 (FR) 12 02123

(51) Int. Cl. G01C 21/00

(52) U.S. Cl. CPC G01C 21/00
USPC 701/3

(57) ABSTRACT

A device for managing strategies to join waypoints of a flight plan for a flight management system comprises: a typing module operating on an item of input data comprising an input waypoint with which is associated at least one operational requirement, for associating with the said item of data at least one typed waypoint comprising an output waypoint and an associated type, the type being determined from a database of types of waypoints, a module for determining strategy to join a typed waypoint, coupled with the typing module, for matching the said type with at least one associated joining strategy from a database of joining strategies.

### CROSS-REFERENCE TO RELATED APPLICATION

This application claims priority to foreign French patent application No. FR 1202123, filed on Jul. 27, 2012, the disclosure of which is incorporated by reference in its entirety.

### FIELD OF THE INVENTION

The present invention relates to the field of Flight Management Systems, usually referred to by the abbreviation “FMS”. More precisely, the present invention relates to a device and a method for determining the strategy to join a waypoint.

### BACKGROUND

The operational scope of an FMS includes the definition of a flyable flight path for the carrying aircraft.

A first difficulty results from the fact that the computed flight path must comply with a large number of constraints. These constraints can for example be associated with procedures defined in navigation databases, or can be related to the flight profile of the aircraft (angle of inclination or “bank angle”, minimum and maximum speed, etc.), or defined by the air company (fuel constraint, etc.). These constraints can also be related to the very definition of the flight plan, for example when the ARINC 424 standard is used, it can be a matter of the way in which a navigation point, or “waypoint”, or a specific A424 leg is flown over.

An additional complexity of the flight path computation is the fact that the navigation databases can sometimes contain inaccuracies and that the definition of certain points can differ from one procedure to another.

The flight path computation carried out by the FMS includes the computation of the transitions between waypoints of the flight plan and maneuvers to be carried out by the aircraft. At present, these computations are carried out in an essentially geometric manner and they use hybrid direct and recursive computation methods in order to converge towards a solution. Because of the abovementioned inaccuracies, the formal definition of the flight path according to these methods can result in discontinuities, corresponding to flight paths that are not directly flyable, or to under-optimized solutions.

An example strategy for constructing a transition is described in the patent FR9816354. This patent describes a purely geometric method for determining a flyable flight path making it possible to join a waypoint with an overflight constraint, based on a tangent of circles computation computed from the authorized turn radius of the aircraft. This geometric method applied outright is no guarantee of the flyability and the continuity of the flight path.

Moreover, in civil aviation, the method of determination of the different strategies to be implemented in order to solve various flight cases is currently based on a geometric analysis of the issue; notably as a function of the angular differences between the different legs, of the lateral difference of the moving object with respect to the flight path, etc. Thus, it is not obvious to foresee exactly what logic will be used in certain specific cases, which can lead to situations where the behaviour of the FMS can appear unnatural.

Moreover, the prior art of current FMSs for managing all of the joining strategies available for complying with a constraint, in order to select one of them, is to test the conditions for activation of each one of them as a function of a particular case and to select the first one satisfying all of the prerequisites. The main difficulty associated with this procedure is the cumbersome nature of the validation process. Certain strategies can be modified in order to meet requirements specific to new functions. It is then necessary to carry out a large number of non-regression tests in order to ensure that this modification will not have an impact on other portions of the FMS which are not, a priori, involved in this evolution.

A purpose of the invention is to overcome the abovementioned disadvantages.

### SUMMARY OF THE INVENTION

The present invention relates to a device for managing strategies to join waypoints of a flight plan for a flight management system of an aircraft comprising:
a typing module operating on an item of input data comprising an input waypoint to which is associated at least one operational requirement, in order to associate with the said item of data at least one typed waypoint comprising an output waypoint and an associated type, the type corresponding to the way in which the aircraft must fly through the output waypoint and being determined from a database of types of waypoints,

a module for determining strategy to join a typed waypoint, coupled with the typing module, in order to match the said type with at least one associated joining strategy determined from a database of joining strategies.

a database (101) of types of waypoint coupled with the typing module,

a database (102) of joining strategies coupled with the module for determining joining strategy.

Advantageously, a type of typed waypoint furthermore comprises at least one additional parameter representing additional constraints.

Advantageously a type is matched with a plurality of associated joining strategies, a joining strategy being provided with a priority depending on values of parameters representing the functioning of the aircraft.

The present invention also relates to a flight management system for an aircraft capable of computing a flyable flight path of an aircraft comprising the device for the management of joining strategies according to one of the preceding claims.

Advantageously, the flight management system furthermore comprises:

a module for formatting a flight plan, coupled with the typing module, for generating a first list of input data comprising an input waypoint with which at least one operational requirement is associated and,

a module for constructing a flyable flight path, coupled with the device for managing joining strategies, for computing and implementing a flyable flight path with a strategy to join a current waypoint onto which the aircraft is cleared, the said strategy being determined from joining strategies provided by the determination module and from a current state of the aircraft.

According to another aspect of the invention, a method is here also proposed for managing strategies to join waypoints of a flight plan executed by an aircraft, comprising the steps consisting of:

loading the current state of the aircraft and loading a typed waypoint comprising a waypoint and a type, a type depending on at least one operational requirement related to flight path constraints and corresponding to the way in which the aircraft must fly through the waypoint, the said point corresponding to the current typed waypoint onto which the aircraft is cleared,

determining a strategy to be used to join the loaded waypoint from the type of the loaded waypoint and from the current state of the aircraft,

implementing the said strategy determined in the preceding step,

checking when the loaded waypoint is reached,

identifying the next typed waypoint when the loaded waypoint is reached,

returning to the loading step with the next typed waypoint.

Advantageously, according to a first variant, the method furthermore comprises the initial steps consisting of:

loading a first list of input data comprising an input waypoint and at least one associated operational requirement,

associating with each item of input data at least one typed waypoint comprising an output waypoint and a type using a database of types of waypoints, a type depending on at least one operational requirement related to flight path constraints,

generating a second list of typed waypoints from the said first list, and where, the loading step loads a point of the said second list corresponding to the current typed waypoint onto which the aircraft is cleared,

the step of determining the strategy to be used is carried out by matching the type of the loaded point with at least one associated strategy, using a database of strategies, then by selection of the strategy to be used from among the said associated strategies according to the current state of the aircraft,

and where the next typed waypoint identified in the identification step (407) is the next point in the second list (L2).

Advantageously according to a second variant, the method furthermore comprises the initial steps consisting of:

loading a first list of input data comprising an input waypoint and at least one associated operational requirement,

associating with each item of input data at least one typed waypoint comprising an output waypoint and a type using a database of types of waypoints, a type depending on at least one operational requirement related to flight path constraints,

associating with each typed waypoint at least one joining strategy by matching the type of the said point with at least one associated strategy, using a database of strategies,

generating a third list comprising the typed waypoints and for each of the points the at least one associated joining strategy, and where,

the loading step loads a point of the third list corresponding to the current typed waypoint onto which the aircraft is cleared, and the at least one associated joining strategy,
the step of determining the strategy to be used consists of selecting a strategy from among the at least one loaded associated strategy according to the current state of the aircraft,
and where the next typed waypoint identified in the identification step is the next point in the third list.

Advantageously, the method according to the invention is executed by a flight management system.

According to another aspect, the invention relates to a computer program product, the said computer program comprising code instructions making it possible to carry out the steps of the method according to an aspect of the invention when the said program is executed on a computer.

### BRIEF DESCRIPTION OF THE DRAWINGS

Other features, purposes and advantages of the present invention will become apparent on reading the following detailed description given with reference to the appended drawings, given as non-limiting examples, and in which:

FIG. 1 describes a device according to the invention,

FIG. 2 illustrates a simple typing mode,

FIG. 3 describes a variant of typing,

FIGS. 4a, 4b, and 4c describe examples of a complex typing mode,

FIG. 5 describes the association of a type with at least one strategy,

FIG. 6 describes a preferred embodiment of a flight management system according to the invention,

FIG. 7 illustrates the first list L1,

FIG. 8 describes the steps carried out by the method according to the invention,

FIG. 9 describes a first variant of implementation of the method described with reference to FIG. 8,

FIG. 10 illustrates the generation of the second list L2,

FIG. 11 describes an example of architecture making it possible to implement the device according to the invention,

FIG. 12 describes a second variant of implementation of the method as described with reference to FIG. 8.

### DETAILED DESCRIPTION

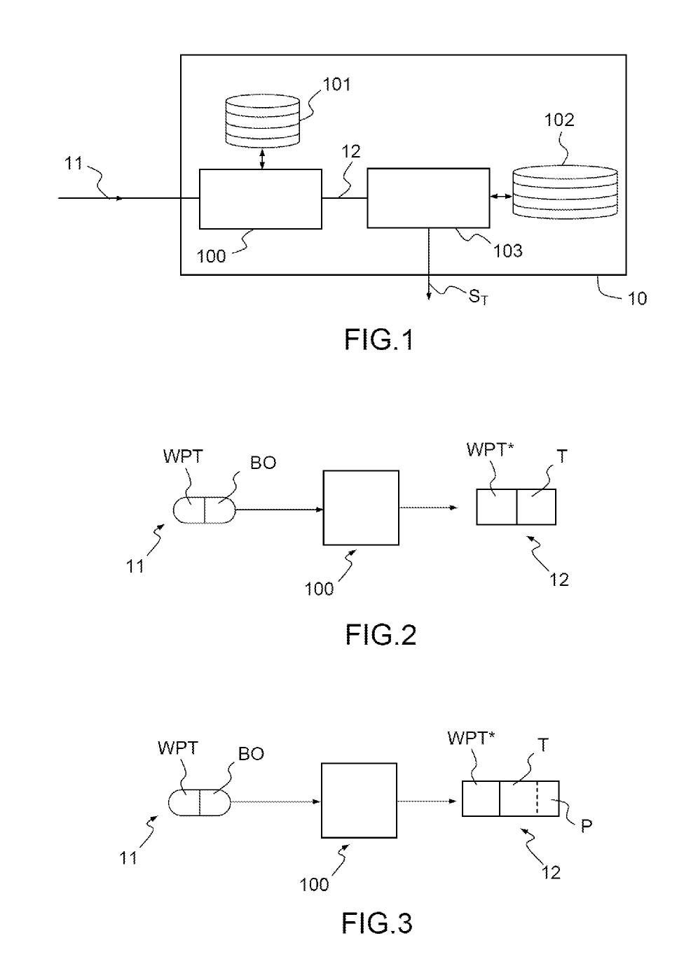

FIG. 1 describes a device 10 according to the invention. The device according to the invention is intended to be built into a flight management system, or FMS, of an aircraft. The device comprises a typing module 100 which operates on an item of input data 11 comprising an input waypoint WPT of a flight plan and at least one operational requirement BO associated with the said waypoint.

The input waypoint WPT is at least defined by its geographic coordinates (latitude, longitude, altitude). An associated operational requirement BO represents the constraints with which the aircraft must fly through the considered waypoint. The general idea is that the operational requirement represents a need that is comprehensible to the pilot and to which there can be one or more responses.

In a non-limiting way, for a commercial flight of an aircraft in civil aviation, the following examples of waypoints provided with an operational requirement (WPT, BO) can be mentioned:

Waypoint/requirement: standard

Waypoint/requirement: to overfly

Waypoint/requirement: optimize turn (join between two segments without overshoot)

Waypoint/requirement: wait (Enter a Hold Pattern)

Waypoint/requirement: overfly with a fixed route

Waypoint/requirement: maintain a circular flight path

Waypoint/requirement: mobile

Waypoint/requirement: target altitude

Waypoint/requirement: enter turn back procedure

Examples of operational requirements are described below in the context of using the A424 standard. The A424 standard is the current standard for expressing a flight plan for a commercial aircraft. This standard defines a set of segments (conventionally called legs) which define a flight path element. This standard has been enhanced progressively with the evolution of navigation techniques and therefore reflects all of the navigation means available at this time, as well as the procedures that can be carried out based on the latter. The A424 is currently composed of 23 types of legs. Some of them are elementary legs, which can therefore be described directly in the form of an Operational Requirement such as those given in the above list. Some legs are more complex, but can be broken down into a succession of Operational Requirements such as those described above. Finally, some legs correspond to a method of expressing a navigational requirement, for example “follow a magnetic bearing given by a compass until interception of a given radial around a radio-navigation beacon on the ground”. It is then necessary to carry out prior computations in order to convert these legs into Operational Requirements such as described above.

In a non-limiting way, for a helicopter flight, one example is a waypoint of given geographic coordinates (latitude, longitude, altitude) with the “stationary” requirement, which signifies that the helicopter must carry out stationary flight over the considered point.

From the operational requirement BO of the input waypoint WPT, the typing module 100 associates with the input data 11 (WPT, BO) at least one typed waypoint 12 (WPT*,T) comprising an output waypoint WPT* and a type T. The type T is determined from a database 101 of types. A type T corresponds to the way in which the aircraft will fly through the output considered waypoint WPT*.

A waypoint of a flight plan is overflown (“sequenced” is the English term used in the FMS field) when the aircraft complies with the conditions for completion of that point, these conditions depending on the state of the aircraft and on data defined for that point. The completion conditions can therefore be represented by a logic equation that is a function of the state of the aircraft and of the aforesaid data. This equation can be a single condition, for example:

Distance(Aircraft Position−Waypoint)<1000m)

or a combination of several conditions, for example:

“have the waypoint in the sector behind the aircraft” OR “have an aircraft altitude higher than the constraint defined for the point”).

The type of the point refers to an arbitrary nomenclature which focuses on the final constraint type of a waypoint WPT*. The waypoints are thus grouped by type, as a function of their completion conditions.

It is essentially a matter of a translation of the Operational Requirements BO, in the general case, in order to change from a set that is usual and convenient from the human point of view to a practical set for computer modelling. Certain types are thus a direct transposition of the operational requirements BO without additional processing. Some types can respond to several operational requirements BO, whilst a BO can be translated into different types depending of these individual cases, the idea being to group, when it is possible, a set of BOs in a single type which can be processed in a generic manner.

In a non-limiting way and for a commercial flight of an aircraft in civil aviation, the following examples of waypoints for which a type has been identified (WPT*, T) can be mentioned:

Standard point defined by its acknowledgement distance

FlyBy point with dynamic distance computation

Point preceding a FlyBy point with dynamic distance computation

Point following a FlyBy point with dynamic distance computation

Point of entry into a hold pattern

Point 2 of a hold pattern

Point 3 of a hold pattern

Point 4 of a hold pattern

Guidance point of an entry in a hold pattern procedure (flyby point on an imaginary segment)

Point of selection between two alternatives

Point with an instruction to change speed/altitude according to a particular mode (for example altitude optimization, optimization of fuel consumption, maximum slope climb, optimization of gliding flight distance, etc.)

Waypoint with piloting instruction (for example maintain an aircraft inclination until a condition is satisfied, etc.)

By way of example, the following waypoints/Operational requirements:

Waypoint/requirement: standard,

Waypoint/requirement: to overfly,

can be associated with the type:

Standard point defined by its acknowledgement distance (distance reduced to an arbitrary minimum in the case of a point to be overflown).

The waypoint/operational requirement “Waypoint/requirement: optimize turn (join between two segments without overshoot)” can for example be associated with the types:

FlyBy Point with dynamic distance computation

Point preceding a FlyBy point with dynamic distance computation

Point following a FlyBy point with dynamic distance computation

FlyBy: optimized connection between two segments.

In a non-limiting manner for a helicopter flight, the operational requirement “stationary” is virtually directly represented by a dedicated type of point, because it is a very specific and elementary element. There is therefore also a “stationary” type of point (clearing to a point with a fixed coordinate until the final condition is completed, which can be temporal for example), to which the operational requirement will be directly equivalent. However, the “stationary” typed point can also be associated with potentially more complex operational requirements.

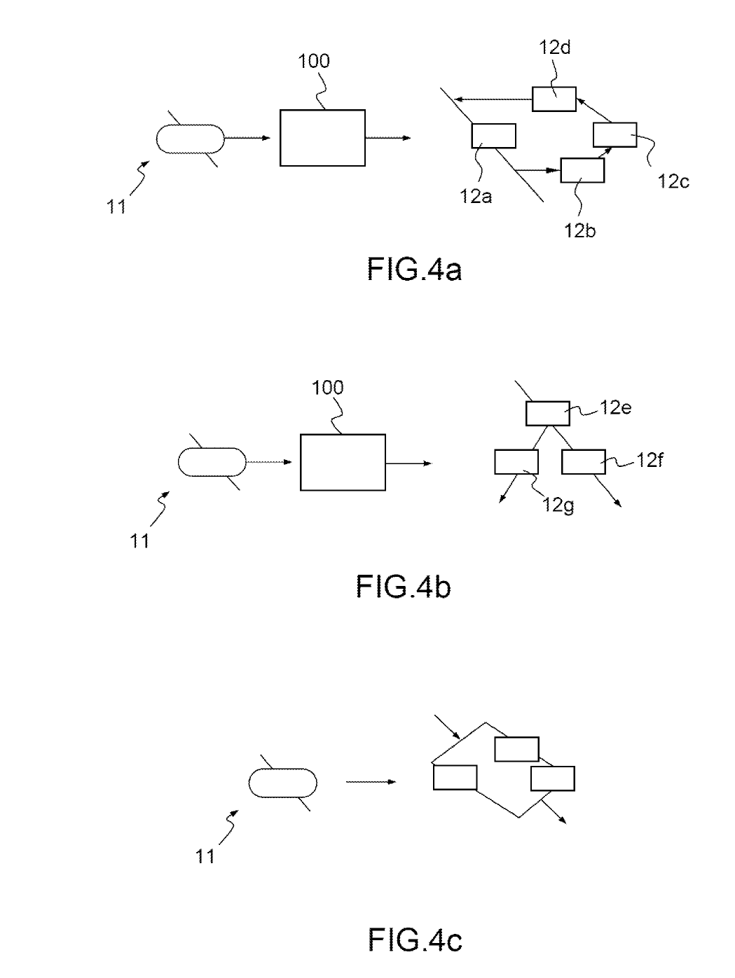

FIGS. 2 and 4 respectively illustrate a simple typing mode and several variants of a complex typing mode for a given input item of data 11, symbolized by an oval, comprising an input waypoint WPT and an associated operational requirement BO. A typed waypoint 12 is symbolized by a rectangle.

FIG. 2 illustrates a simple typing where the typing module 100 associates a single typed waypoint 12 (WPT*, T) with the input item of data 11 (WPT, BO). In this case the output waypoint WPT* is equal to the input waypoint WPT, which signifies that they have the same geographic coordinates.

An example of simple typing is an input item of data 11 corresponding to a waypoint WPT with an overfly Operational Requirement BO (flying exactly vertically over the point). The elementary typing is the overfly of the waypoint WPT* associated with a dynamic acknowledgement distance. In the case of the transcription of a WPT with overfly BO, the acknowledgement distance associated with the type of the WPT* will then be parameterized in such a way as to reflect this vertical “exact passing over” in the real world. In practice this is represented by a distance of the order of a few tens of metres, or even of about one hundred metres, which reflects the usual accuracy of air navigation.

FIG. 3 describes a variant of typing, according to which the type T furthermore comprises at least one additional parameter P representing additional flight path constraints, such as “Target speed on overflying a point”, “overfly time”, etc. This variant is compatible with simple typing and with complex typing.

FIG. 4 describes several complex typing variants. In a complex typing, the module associates a plurality of typed waypoints with an input item of data 11. This plurality is not necessarily constituted by a simple succession of typed points but can be constituted by a tree structure.

FIG. 4a describes the typing of an input point corresponding to a “hold pattern” operational requirement. The different typed waypoints 12a (WPT*a, Ta), 12b (WPT*b, Tb), 12c (WPT*c, Tc), 12d (WPT*d, Td) each have different geographic coordinates and an associated type Ta, Tb, Tc, Td. In this case, the aircraft flies in a loop which breaks down into a series of typed points 12a, 12b, 12c, 12d that the aircraft must sequence until it has received an exit order. The aircraft flies the loop as long as the order has not been received. Once the order has been received, it finishes the loop and leaves it after flying over the exit point.

FIG. 4b describes a typing of an input point corresponding to an operational requirement corresponding to an alternative flight plan with a point of no return. If, at the moment of choice in 12e (WPT*e, Te), a certain condition has not been satisfied, the aircraft will leave on an alternative branch of the flight plan passing through 12g (WPT*g, Tg) and, if it is complied with, it will continue the main flight plan passing through 12f (WPT*f, Tf).

FIG. 4c describes an input point typing corresponding to the operational requirement corresponding to an alternative route finally leading to the same point. For example this case corresponds to a segment requiring a high current level of accuracy in order to be authorized, without which the aircraft will be constrained to carry out a longer procedure in order to arrive at its destination.

The device 10 also comprises a module 103 for determining joining strategy coupled with the typing module, in order to match the type T of a typed waypoint with at least one associated joining strategy S_{T}.

A strategy S_{T} is determined from a strategy database 102.

In a generic manner, a joining strategy corresponds to one or more maneuvers, which can be arranged in a simple or in a complex manner, successive or simultaneous, and whose final objective is to bring the moving object executing them, that is to say the aircraft, to fulfill the conditions for completing the typed waypoint in progress.

A manoeuvre is an elementary action having an affect on the flight path (in the broad sense and not solely geometric but also temporal) or on the state of the aircraft such as: a turn towards a heading, at a rate and over a given time, the acquisition of an altitude at a given climb speed and thrust, a change of speed, a change of aerodynamic configuration of the aircraft, etc.

A type can be associated with a single strategy or with a plurality of strategies as shown in FIG. 5. The type T5 has a single associated strategy S_{T5}, whilst the types T1 and T4 have a plurality of associated strategies respectively described by the sets S_{T1} and S_{T4}. This signifies that, during the computation of the flight path, the joining of these waypoints will be able to be carried out according to several possibilities, depending on the case in progress.

The different possible types are listed in a types database 101 and the different possible strategies are listed in a strategies database 102. These two databases are independent from each other.

In a non-limiting way, for a commercial flight in civil aviation, the following examples of strategies to join a waypoint can be mentioned:

Default strategy to join a point (the aircraft tries to aim at the point to the best of its ability)

Strategy for managing unattainable points (anticipation of turn and counter-turn radii if the point is not directly accessible)

Strategy to join a segment at 45°

Strategy for choosing turning circles to reach a point with a given short-distance route by minimizing the manoeuvre zone

Strategy for choosing turning circles to reach a point with a given short-distance route avoiding flying over the exit line

Strategy for anticipating the wind in order to maintain a circular flight path whilst remaining within the limitations of the aircraft

Strategy for stationary holding (or stationary ascending/descending)

Strategy for choosing entry into a holding pattern

Strategy for leaving a holding pattern

Strategy to join a point whilst minimizing the “Cross Track Error” or CTE.

Cross Track Error: The lateral positioning error of an aircraft with respect to its ideal flight path. It is a matter of orthogonally projecting the current position of the aircraft onto the flight path that it is supposed to follow. The CTE is therefore the distance between the real position of the aircraft and its projection on the flight path.

An elementary example of association of a type of point and a unique strategy is the association of an “optimization of the joining turn” typed waypoint with a dedicated strategy:

This type of point carries out a transition from one flight plan segment to another whilst avoiding, during the turn, overshooting the arrival segment but keeping as close as possible to the lines of arrival and departure.

The associated strategy is therefore that the aircraft, when the “optimization of the joining turn” typed point becomes active, is moving towards this point by computing, as a function of its speed and of its mechanical flight limitations, the distance necessary for it to carry out a turn with a change of course corresponding to the angle between the two lines. It thus determines, on approaching this point, if the distance is too long, in which case it continues to direct itself towards it or if, on the contrary, it has reached the appropriate distance, in which case it carries out its turn according to the acceptable Flight Mechanics parameters in order to aim at its next typed waypoint.

An advantage of the device according to the invention is that it exhibits a modular architecture making it possible to define strategies independently, on the one hand, and typed points representing the way in which the aircraft must fly through the waypoint.

The list of associated strategies can easily be extended to new strategies, for example dedicated to specific issues, such as 4D insertion maneuvers with respect to a moving object, etc. The management of the adding of a strategy is facilitated with an explicit definition of the cases where it can be used with respect to the corresponding types of points. It is also easy to manage which authorized points are to be matched with one or other of the strategies.

Similarly, all of the point types can also be extended according to requirements.

The architecture of the device thus allows a strong independence between the strategies that will be used and their field of application. The adding of a new strategy does not impose overall re-verification but simply tests on the points using it. During the addition of a new strategy, the cases where that strategy is likely to be used are controlled, limiting the risks of using a given strategy in an inappropriate flight phase.

When there is a plurality of strategies associated with a given type, the associated strategies are given a priority (computation mode) depending on the values of the parameters representing the functioning of the aircraft. The choice between the different associated strategies will be carried out according to these values for the case in progress. The conditions for switching from one strategy to another will also have to be provided.

The choice between the different strategies will be carried out for example by a mechanism of the type “if” . . . “then” . . . “elseif” . . . “then” . . . “otherwise”. Thus, each strategy is allocated with a logic condition for activation. The device tests, in order of priority, all of the activation conditions of the different strategies which are allocated to a type of WPT* until one is found which will be validated and which is the strategy used. Because of aeronautical imperatives of the “Failsafe” type, there is a final default strategy for all of the types which does not itself have an activation condition. It will therefore necessarily be activated if all of the higher priority strategies are not activated, which makes it possible to ensure that, whatever the situation may be, there will always be an applicable strategy to solve the typed waypoint in progress.

By way of example, a common typed waypoint corresponding to the requirement to carry out an optimized connection between two segments (“flyby”) has a priority strategy (of the type described above). For this precise type, only one single strategy is therefore defined, which by definition is the default strategy. However, in certain cases, the strategy consisting in computing the start of turn distance in order not to “overshoot” results in strongly anticipating the waypoint (the case of a very tight turn tending at the limit towards a 180° turn where the computation would give an infinite anticipation distance). In certain zones, non-overshooting is less important than the fact of remaining relatively close to the flight path. In which case, a variant of the preceding point can be implemented, a variant in which the optimized turn strategy is used only if the angle of the turn is less than a limit value (for example 160°). If the turn is more sharp than that, then the strategy consists in approaching the point until reaching a fixed arbitrary distance and then, once this distance is reached, considering the point as reached and therefore moving on to the next one.

Another example illustrating the management of the strategies is the procedure of entering a procedure of the “holding pattern” type. As described above, the “holding pattern” is represented by a point with an Operational Requirement BO to which parameters for defining the “pattern” itself (direction of rotation, length of the leg, required speed) are added. This BO is represented by a succession of four typed points with their own strategies.

Regarding the first point used for entrance into the procedure: depending on its arrival sector, the aircraft must carry out different and relatively complex maneuvers in order to become inserted in the “pattern” without disturbing the traffic which could already be present. Thus, as a function of the relative position of the aircraft entering the “Hold”, it is necessary to choose from among four entrance strategies (the four strategies in this case being mutually exclusive, their relative priorities having no effect on the final choice). However, it can happen, in very particular cases, that the choice of entry according to the sector is not sufficient, notably if the aircraft is not aiming towards the entrance point because of a preceding leg which has brought it towards another route. In this case, the device makes it possible to fix a minimum distance below which the aircraft will carry out a rapid entry strategy, for example by seeking to move as quickly as possible to the entry point of the “Hold” with the direction defined by the “Hold”.

The device according to the invention can be applied in a flight management system (FMS) for computing a flyable flight path, that is to say one without discontinuities and that can actually be flown by the aircraft.

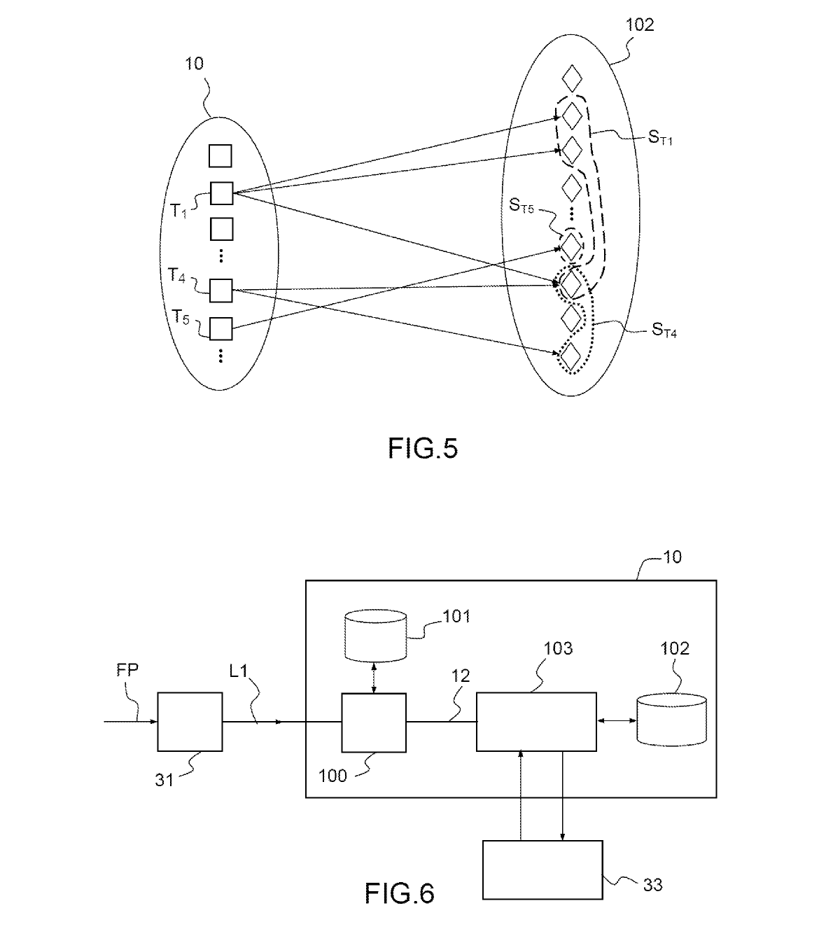

FIG. 6 describes a preferred embodiment of the FMS according to the invention. The function of the FMS according to the invention in this case is to compute a flight path that is flyable by the aircraft on the basis of a flight plan (FP) defined by a succession of items of information making it possible to construct a flight path corresponding to a given mission. There are several types of flight plan depending on the type of mission to be carried out and on the type of aircraft.

A first example of a flight plan relates to commercial aviation. Current FMSs result from the requirements of commercial aviation. Because of this, the flight plan concept in a conventional FMS is directly inspired by the typical flight plan of a commercial flight. This type of flight plan breaks down into several successive flight phases: (Taxiing), Takeoff, Climb, Cruise, Descent, Approach, Landing, (Taxiing). The taxiing phases are shown here in order to illustrate the current trend, but, correctly speaking, they are not part of the flight plan and are not included by most FMSs.

In addition to the main flight plan, FMSs offer the additional management of a “secondary” flight plan which will correspond to a potential requirement to divert a civil aircraft to another airport, in the case of an on-board failure or of non-availability of the arrival site.

In all cases, these different phases of the flight plan are described by the Arinc 424 standard which defines a typology of 23 elements (legs). Any civil flight plan is therefore a combination of these legs which represent traditional methods of navigation. These 23 legs therefore constitute the operational core of current FMSs (cf A424 standard for a listing of all these legs).

Another example relates to SAR procedures. This is a type of flight which aims to patrol and sweep an area in the most effective way possible in order to find an object within it (typical example: searching for persons after a shipwreck or an air crash). The most conventional SAR procedure is the sweeping of the area using parallel there-and-back paths. An additional complexity is that each branch of this coverage is considered to be carried out “wings flat”. Thus, at the end of each branch, the aircraft must make a ¾ turn in order to return and present itself in line with the next branch. There is no structure in the A424 standard making it possible to carry out this manoeuvre. It is therefore particularly complicated and difficult to include this function in a conventional FMS whose core is specifically designed for the A424 standard.

LLF (Low Level Flight) navigation is another navigation function which is required in certain very specific fields. In this case it is a matter of an essentially military context in which the aircraft tries to fly as close as possible to the ground in order to gain improved protection/stealthiness.

The FMS comprises the device according to the invention and furthermore comprises a module 31 for formatting the flight plan FP coupled with the typing module 100. The formatting module converts the flight plan FP into a first list L1.

The formatting module, called “Routings”, is an interface between a flight plan FP as defined above and the management device 10. Typically a “Routing” formatting module is associated with each type of flight plan and with the type of aircraft intended to execute it. The strategy managing module 10 is generic and is interfaced with all types of flight plans using the adapted “Routings” module.

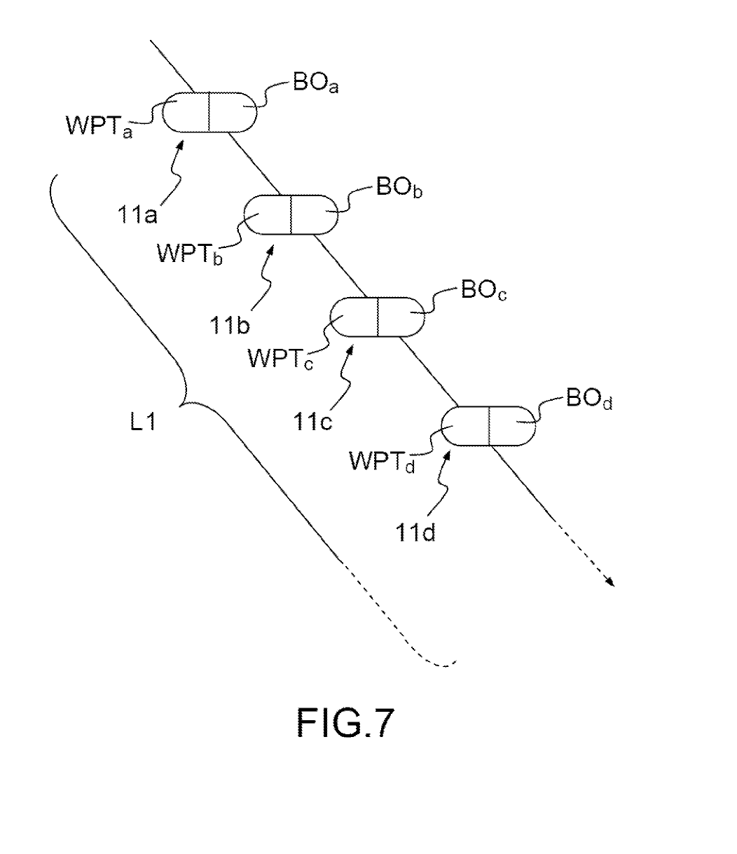

The first list L1, shown in FIG. 7, is a transcription of the flight plan in the form of a series of waypoints WPTa, WPTb, WPTc, WPTd with which is respectively associated at least one operational requirement BOa, BOb, BOc, BOd and forms a series of input items of data 11a, 11b, 11c, 11d, an item of data being such as described for example with reference to FIG. 2.

The device 10 carries out a typing of each element 11a, 11b, 11c, 11d, etc. of the list L1 and generates a list comprising all of the typed points 12i, 12₁, 12₂, 12₃, etc. indexed by an index i, corresponding to the typing of each item of data 11a, 11b, etc.

The FMS furthermore comprises a flight path construction module 33 coupled with the device 10 according to the invention, which, in flight, goes through the list of typed waypoints 12i, processing the typed waypoints one by one according to the progression of the aircraft. The flight path construction module 33 interrogates the device 10 whilst indicating to it which typed point the aircraft is currently cleared onto. The device 10 provides the joining strategies S_{T} associated with the current typed point.

If there are several associated strategies, the choice of the strategy to be used Se from among the different associated strategies S_{T} is carried out as a function of the parameters defining the current state of the aircraft, for example in the form of a list of values of parameters. Thus, the flight path construction module 33 computes and uses a flyable flight path with one strategy Se to join current waypoint.

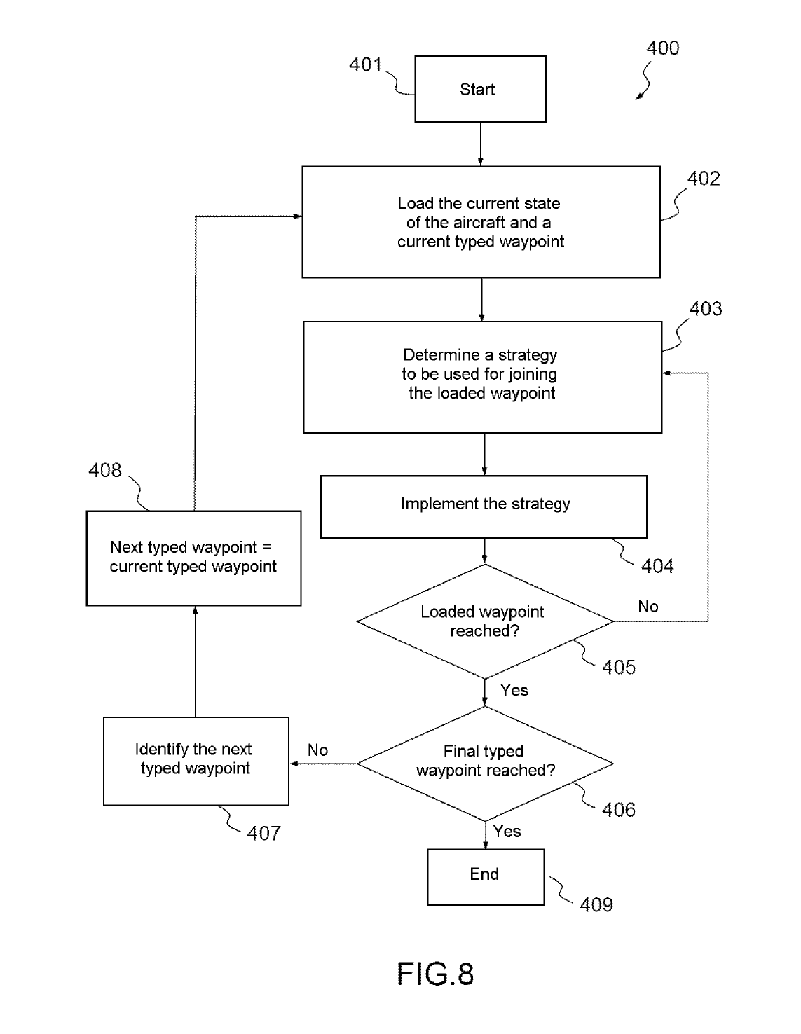

FIG. 8 shows the steps 400 performed by the method according to the invention for managing the strategy to join waypoints in a preferred implementation. The method makes it possible to compute the strategy to be used to join the typed waypoint onto which the aircraft is cleared.

In a first step 402, the method loads the current state of the aircraft and a current typed waypoint.

The current typed waypoint is a typed waypoint such as preferably described with reference to FIGS. 2, 3 and 4, onto which the aircraft is cleared and which it must join.

The type T of the current typed waypoint has been chosen from among a set of types included in a database, such as described with reference to FIG. 1.

The current state of the aircraft is characterized by values of parameters.

These parameters are for example (the data in brackets can vary according to the reference chosen but the parameter values they represent remain the same):

Its position (lat, long, alt)

Its speed vector (speed norm, route, slope)

Its weight (or quantity of remaining fuel, both quantities normally representing the same thing, except in the case of a military aircraft able to jettison payloads, which modifies its weight profile, in which case both of the values are necessary)

its current aerodynamic configuration (usually, the state of the flaps, spoilers and leading edge slats which make it possible to optimize the aerodynamic profile of the aircraft)

Its system configuration (state of the on-board systems, list of failures—engines or others—which can have an impact on the capabilities of the aircraft)

Its current objective (point aimed at, control segment, etc.)

The first two parameters (position and speed) are mandatory, the others depend on the requirements and on the availability of information.

In the next step 403, the method determines a strategy to be used Se to join the loaded waypoint, from its type T and the associated strategies S_{T} such as described with reference to FIG. 5, and from the current state of the aircraft.

The strategy Se is determined from the associated strategies S_{T} listed in a strategies database 102, such as described with reference to FIG. 1.

In the next step 404, the strategy Se determined in the preceding step is used. The use of the strategy consists in determining the exact flight path of the moving object from its current position until the conditions for acknowledgement of the point in progress are satisfied, considering its performance and its limitations. The determination of the flight path implies at least its geometric definition, but more generally also its temporal definition (at what time the aircraft will be at key points, or even at all points along the flight path) and weight (how much fuel will it have consumed in order to reach key points or even any point in the flight path as a function of its initial state).

In step 405, the method checks if the current point has been reached by the aircraft.

If the current point has not been reached, the method loops back to step 403.

If the current point has been reached, the method checks if the final typed point has been reached. If the final typed point is the last point in the list of typed waypoints, the method stops at 409.

If the final typed point has not been reached, the method identifies, in 407, the next typed waypoint, which corresponds to the next typed waypoint in the list of typed waypoints, which is the next typed waypoint that the aircraft must join. The next typed waypoint becomes, in 408, the current typed waypoint and the method loops back to 402.

The typing of the point, then the association of its type with a determined number of listed strategies called associated strategies, as well as the choice of the strategy to use from among the associated strategies as a function of the current state of the aircraft, makes it possible to manage a set of strategies in order to optimize the flight path to join a point according to different situations.

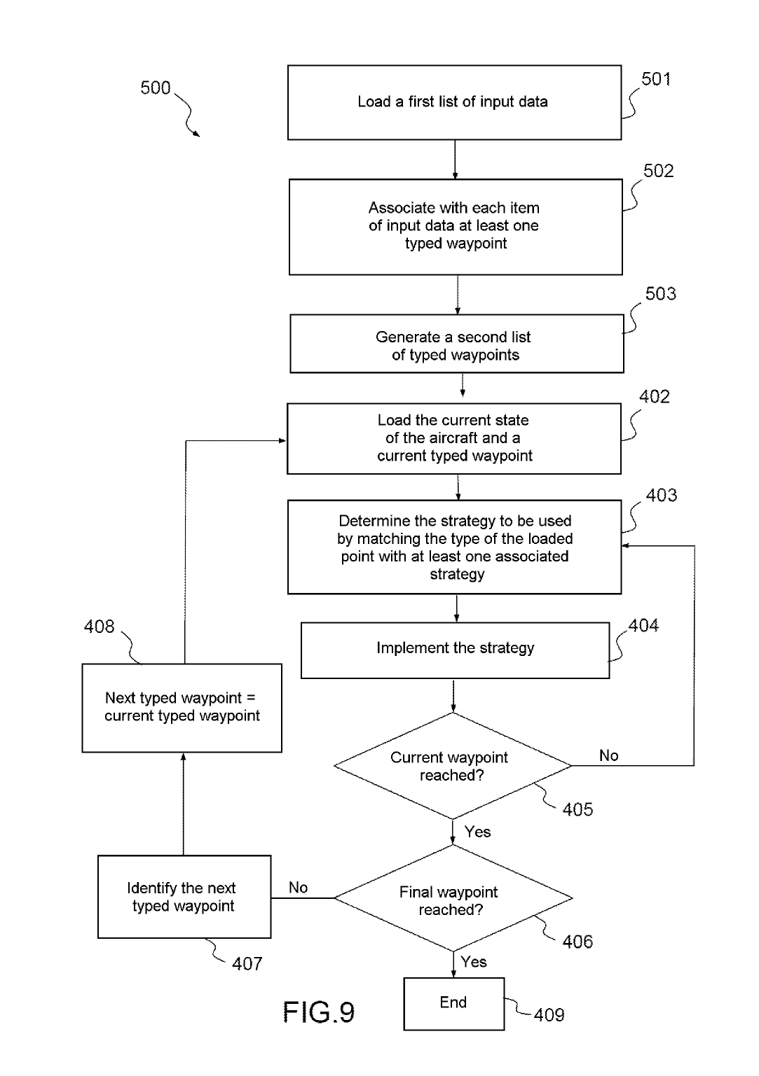

FIG. 9 describes a first variant of the method 500 described with reference to FIG. 8. The method 500 comprises the steps to allow the computation and the construction of the flight path from a flight plan FP expressed according to a defined standard.

The flight plan FP is firstly converted into a first list L1 of input data (11a, 11b, 11c, 11d, etc.) such as described with reference to FIG. 7. Each item of input data 11a, 11b, 11c, etc. comprises an input waypoint WPTa, WPTb, WPTc, WPTd, etc. and at least one associated operational requirement BOa, BOb, BOc, BOd, etc.

The method 500 described in FIG. 9 comprises the following initial steps:

In a first step 501 the method loads the first list L1 of input data (11a, 11b, 11c, 11d, etc.).

In the next step 502, the method associates each item of input data with at least one typed waypoint such as described with reference to FIGS. 2 to 4. Each typed waypoint comprises an output waypoint WPT* and a type T comprised in a database 101 of types of waypoint. A type is determined according to an operational requirement BO, such as described in FIGS. 2 to 4.

In the next step 503, the method generates a second list L2 of typed waypoints 12ᵢ indexed by the index i: 12₁, 12₂, 12₃, etc. The typed waypoints of L2 correspond to a series of typed waypoints associated with the input data 11a, 11b, 11c, 11d, etc. taken successively in L1. In the list L2, the typed waypoint 12ᵢ₊₁ is the typed waypoint following the typed waypoint 12ᵢ.

In flight, the FMS successively chooses each typed waypoint of L2 as the current point onto which the aircraft is cleared. By default, the FMS always takes the next point at the time when the current point has been acknowledged. There are exceptions, essentially when there is pilot intervention or when the FMS changes from one variant to another of the flight plan.

The loading step 402 loads the typed waypoint of the second list L2 which is the current point.

The step of determination 403 of the strategy to be used Se to join the current point is carried out in two stages. Firstly, from the type of the current typed waypoint, the method determines the at least one associated strategy S_{T} using a database of strategies 102.

Then, secondly, the strategy to be used Se is selected from among the at least one associated strategy as a function of the current state of the aircraft and by using the priorities and the rules for switching from one strategy to another.

Once determined, the strategy to be used is implemented to compute the flight path of the aircraft until current point is reached.

Once current point is reached, the next typed point in the list L2 becomes the current waypoint which is loaded in 402.

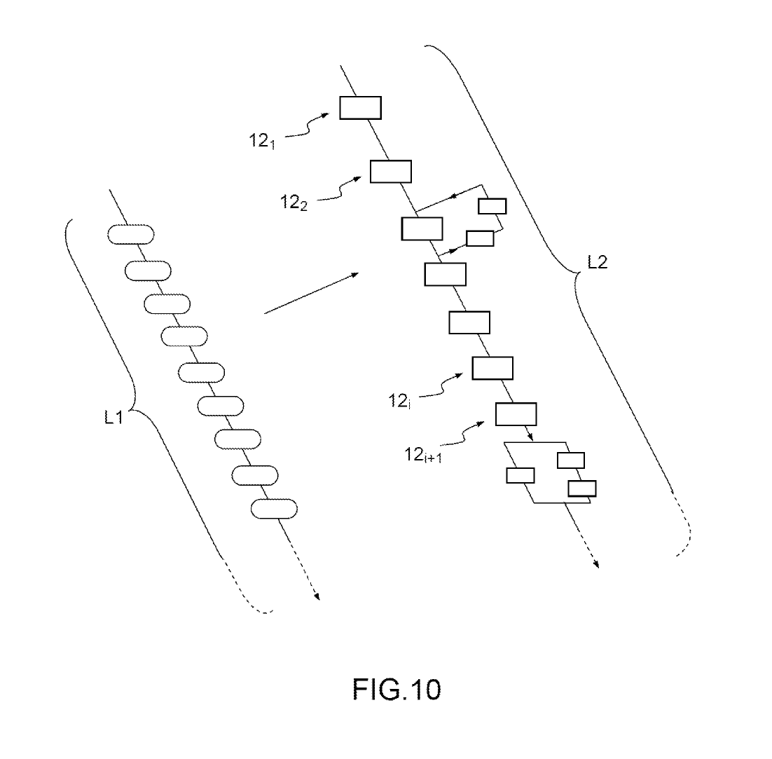

FIG. 10 illustrates the generation of the list L2 from the list L1.

An advantage of the method is that it makes it possible to solve all of the conflicts and discontinuities that can occur at the transition points, and thus to compute a continuous and optimum flight path.

An example of a flight path issue solved by the method according to the invention is a conventional complex flight case, which is a series of waypoints expressed by the pilot, close to one another and each having overflight constraints. The conventional solution in current FMSs is to compute, on one hand, a departure geometric flight path from the first point and, in the backward direction, an arrival geometric flight path at the next point. The issue occurs when there is no flyable connecting solution.

The default strategy used consists in detecting the points which are in fact unattainable directly as a function of the minimum turn radius that can be flown by the aircraft. If the aircraft cannot reach the point by trying to direct itself towards it, the strategy used is to leave on an opposite turn in order to distance itself in order to leave the unattainable zone as quickly as possible before reversing the turn in order to join it. This strategy makes it possible to guarantee that, in all cases, a flyable flight path making it possible to comply with all the overflying constraints can be determined. However, in certain cases, the overflying constraint is not necessarily of priority and it is more important to not become too distant from the minimum flight path between the different points. Thus, an additional strategy can be implemented to take account of the acceptable “Cross Track Error” and therefore to widen the acknowledgement distances of the points to be overflown which are of less priority in order to remain within the acceptable time.

Other flight path issues solved by the method according to the invention are for example: a transition between two flight phases, a specific navigation procedure (for example of the Required Navigation Performance type), the taking into account of a time constraint (for example of the Required Time of Arrival type), a speed constraint, an altitude constraint, etc.

Another advantage is that the optimization of the flight path is achieved by integrating the aircraft's performance, as a function of which the solution can vary.

Another advantage is that the proposed method is generic and can be applied no matter what the considered aircraft and its associated performance may be.

It is compatible with all types of wing configurations, fixed or rotary, by taking account of the specific features of each:

fixed wing: safety imperative not to fly below a defined speed (stalling)

rotary wing: specific nature of the flight of a helicopter capable of carrying out stationary flights or ascents/descents at zero ground speed.

The method according to the invention is also compatible with different types of missions:

civil mission: conventional flight plan of an aircraft connecting two airports (takeoff, climb, cruise, descent and approach) accompanied by a secondary flight plan making it possible to go to a diversion airport in the event of a meteorological event or of a failure,

search missions such as SAR (Search and Rescue) patterns making it possible to fly over the whole of an area,

military missions such as flight refueling, coordination between several aircraft, very low altitude flight, terrain following, weapon firing.

Moreover, the method is suitable for managing the long term aspects of a flight which connects very distant points on the surface of the globe (transatlantic flight) but also for managing short term issues such as approach or transition between flight segment procedures.

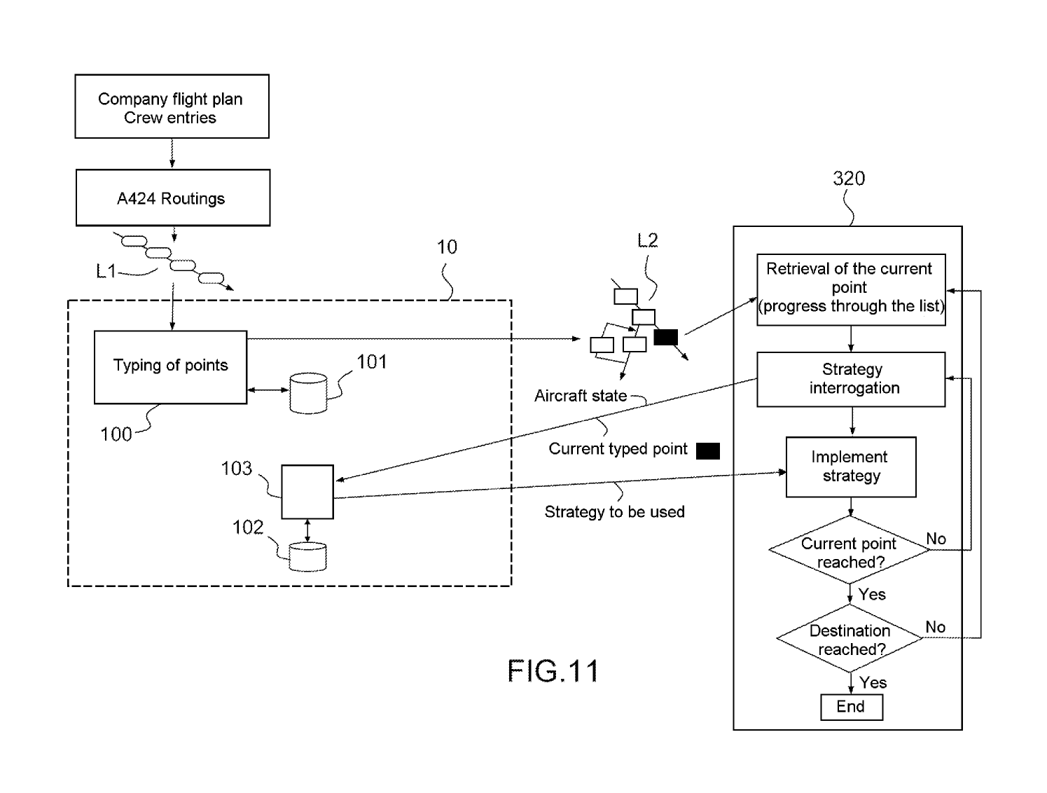

An example of architecture making it possible to implement the device 10 according to the invention and to use the method 500 according to the invention to compute the flight path of an aircraft carrying out a mission of the commercial flight type is described in FIG. 11.

The crew defines the flight plan by searching in a database defined by the ARINC 424. The formatting module 31 “Routings” translates the formalism of the standard into a series of waypoints associated with operational requirements in the form of a list L1 and supplies it to the management device 10. The management device 10 generates a list L2 of typed waypoints with the typing module 100 and the database of types 101. The flight path construction module 320 progresses through this list in flight. The module 320 retrieves the current waypoint from the list L2 in order to clear the aircraft onto it and then interrogates the device 10, more particularly the matching module 103, providing it with the current typed waypoint and the current state of the aircraft. The module 103 determines the strategies associated with the type of the current point, using the database of strategies 102, and chooses from among the latter strategy to use according to the current state of the aircraft. The strategy to be used is communicated to the flight path computation module 320 which uses the selected strategy until current point is reached. The use of the strategy consists in computing the flight path of the moving object explicitly and completely whilst complying with the elements of the description of the strategy used.

By way of example, in the case of the solution for a standard point that is currently unattainable, the strategy used is to turn away from this point as long as it is unattainable and then, once it is attainable, to reverse the turn in order to head towards it until the condition of acknowledgement of that point is obtained.

From this formal definition of the strategy, its implementation is, based on current aircraft state (notably its position, its speed vector and its limitations) to compute the 5D flight path, the point after which the objective becomes attainable and the joining flight path starting from there, with the characterization of the times of sequencing, of the fuel consumed, etc.

The flight path computing module then retrieves from the list L2 the next typed waypoint, which becomes the new current waypoint, and reiterates the interrogation of the management device 10.

It is possible to exchange, depending on the carrier aircraft, the type of “Routing” module and also to make several cohabit within the same aircraft in order to complete several types of missions during a single flight.

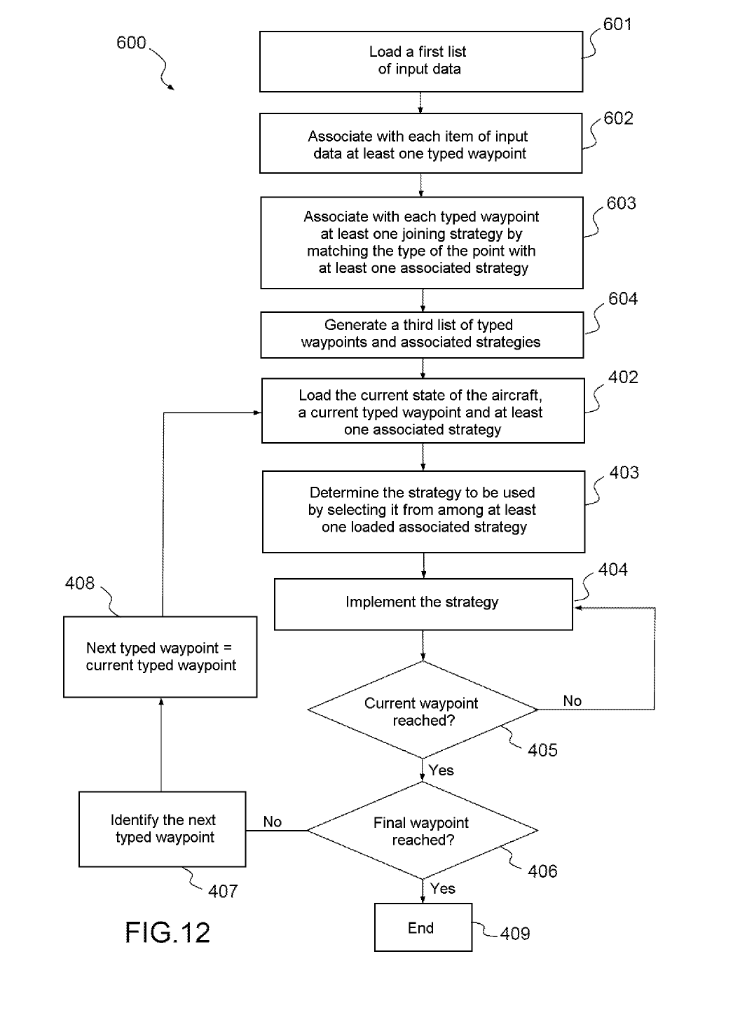

FIG. 12 describes a second variant implementation of the method such as described with reference to FIG. 8. The method 600 comprises the steps allowing the computation and the construction of a flight path from a flight plan FP expressed according to a defined standard.

The flight plan FP is firstly converted into a first list L1 of input data (11a, 11b, 11c, 11d, etc.) such as described with reference to FIG. 7. Each item of input data 11a, 11b, 11c, 11d, etc. comprises an input waypoint WPTa, WPTb, WPTc, WPTd, etc. and at least one associated operational requirement BOa, BOb, BOc, BOd, etc.

The method 600 described in FIG. 12 comprises the following initial steps:

In a first step 601 the method loads the first list L1 of input data (11a, 11b, 11c, 11d, etc.).

In the next step 602, the method associates each item of input data with at least one typed waypoint such as described with reference to FIGS. 2 to 4. Each typed waypoint comprises an output waypoint WPT* and a type T comprised in a database 101 of types of waypoint. A type is determined as a function of an operational requirement BO, such as described in FIGS. 2 to 4.

In the next step 603, the method associates with each typed waypoint at least one joining strategy by matching the type of the typed waypoint with at least one associated strategy S_{T}, the strategies being comprised in a database 102 of strategies.

In the next step 604, the method generates a third list L3 comprising the typed waypoints and for each of the points the at least one associated strategy (S_{T}).

The next step corresponds to the loading step 402 for loading the typed waypoint of the third list L3 which is the current waypoint, as well as the at least one strategy which is associated with it.

The step of determination 403 of the strategy to be used is carried out by selecting a strategy Se from among the at least one loaded associated strategy S_{T}, as a function of the current state of the aircraft.

Once determined, the strategy to be used is implemented in order to compute the flight path of the aircraft until current point is reached.

Once current point has been reached, the next typed point in the list L3 becomes the new current waypoint which is loaded in 402.

The discrepancy between the two variants consists in the location of the strategy choosing module and in the fact of knowing if the different strategies associated with a point are implemented permanently in the point, once the latter has been instantiated, or if on the contrary the determination will be carried out dynamically on the basis of the type of point by questioning the database again just before implementing the strategy.

The two variants are equivalent from a functional point of view. The advantages of one or the other occur at the level of implementation and of architecture constraints.

If for example, for hardware optimization reasons, the strategies and flight path construction modules are on separate computers and the communication link between the two is of low performance, it is preferable to provide the different strategies directly in the points. The flight path construction module will then be relatively autonomous for the continuation of the processing and will minimize the communications which are costly in terms of performance.

If on the contrary the link between the two computers is very reactive, it will be more advantageous to transmit points with only their type to the flight path construction module which will then send more frequent requests to the strategies management module which will itself assume responsibility for carrying out the strategy choosing computations, the flight path construction carrying out only the computations necessary for the implementation.

The method according to the invention is typically executed by the flight management system (FMS) of an aircraft.

A preferred implementation of the method according to the invention is carried out in a flight path computation by state vector, with a direct approach and without recursive iteration. The continuity of the flight path is thus guaranteed in all cases.

The method according to the invention is compatible with constraints of the 4D type, such as following a moving object, terrain following, etc.

The way of modelling the constraints by the BO/Typed Point/Strategy set makes it possible to process navigation elements that are more complex than a simple reference flight path defined geometrically with at most points serving as time constraints. The claimed device and method make it possible to specify a stationary point over which it is necessary to remain for a fixed period for example, or to provide the coordinates of a target point with values reflecting the temporal displacement of another moving body, which is not possible in the principles currently used by conventional FMSs.

1. A device for managing strategies to join waypoints of a flight plan for a flight management system of an aircraft comprising:
a typing module operating on an item of input data comprising an input waypoint with which is associated at least one operational requirement, the said typing module associating with the said item of data at least one typed waypoint comprising an output waypoint and an associated type, the type corresponding to the way in which the aircraft must fly through the output waypoint and being determined from a database of types of waypoints,
a module for determining strategy to join a typed waypoint, coupled with the typing module, the said determination module matching the said type with at least one associated joining strategy determined from a database of joining strategies,
a database of types of waypoint coupled with the typing module,
a database of joining strategies coupled with the module for determining joining strategy.

2. The device according to claim 1, wherein a type of typed waypoint furthermore comprises at least one additional parameter representing additional constraints.

3. The device according to claim 1, wherein a type is matched with a plurality of associated joining strategies, a joining strategy being provided with a priority depending on values of parameters representing the functioning of the aircraft.

4. A Flight Management System for an aircraft capable of computing a flyable flight path of the aircraft comprising the device for the management of joining strategies according to claim 1.

5. The Flight Management System according to claim 4, further comprising:
a module for formatting a flight plan, coupled with the typing module, generating a first list of input data comprising an input waypoint with which at least one operational requirement is associated and,
a module for constructing a flyable flight path, coupled with the device for managing joining strategies, computing and implementing a flyable flight path with a strategy to join a current waypoint onto which the aircraft is cleared, the said strategy being determined from joining strategies provided by the determination module and from a current state of the aircraft.

6. A method for managing strategies to join waypoints of a flight plan executed by an aircraft, comprising the steps:
loading the current state of the aircraft,
loading a typed waypoint comprising a waypoint and a type, a type depending on at least one operational requirement related to flight path constraints and corresponding to the way in which the aircraft must fly through the waypoint, the said point corresponding to the current typed waypoint onto which the aircraft is cleared,
determining a strategy to be used to join the loaded waypoint from the type of the loaded waypoint and from the current state of the aircraft,
implementing the said strategy determined in the preceding step,
checking when the loaded waypoint is reached,
identifying the next typed waypoint when the loaded waypoint is reached,
returning to the loading step with the next typed waypoint.

7. The method according to claim 6, further comprising the initial steps:
loading a first list of input data comprising an input waypoint and at least one associated operational requirement,
associating with each item of input data at least one typed waypoint comprising an output waypoint and a type using a database of types of waypoints, a type depending on at least one operational requirement related to flight path constraints,
generating a second list of typed waypoints from the said first list, and
wherein the loading step loads a point of the said second list corresponding to the current typed waypoint onto which the aircraft is cleared, and
wherein the step of determining the strategy to be used is carried out by matching the type of the loaded point with at least one associated strategy, using a database of strategies, then by selection of the strategy to be used from among the said associated strategies according to aircraft current state, and
wherein the next typed waypoint identified in the identification step is the next point in the second list.

8. The method according to claim 6, further comprising the initial steps:
loading a first list of input data comprising an input waypoint and at least one associated operational requirement,
associating with each item of input data at least one typed waypoint comprising an output waypoint and a type using a database of types of waypoints, a type depending on at least one operational requirement related to flight path constraints,
associating with each typed waypoint at least one joining strategy by matching the type of the said point with at least one associated strategy, using a database of strategies,
generating a third list comprising the said typed waypoints and for each of the points the said at least one associated joining strategy, and
wherein the loading step loads a point of the said third list corresponding to the current typed waypoint onto which the aircraft is cleared, and the said at least one associated joining strategy, and
wherein the step of determining the strategy to be used consists of selecting a strategy from among the at least one loaded associated strategy according to the current state of the aircraft, and
wherein the next typed waypoint identified in the identification step is the next point in the third list.

9. The method according to claim 6 executed by a flight management system.

10. The method according to claim 7 executed by a flight management system.

11. The method according to claim 8 executed by a flight management system.

12. A computer program product, the said computer program comprising code instructions making it possible to carry out the steps of the method according to claim 6, when the said program is executed on a computer.
